(19) United States
(12) Patent Application Publication
(10) Pub. No.: US 2016/0223933 A1
(43) Pub. Date: Aug. 4, 2016

(54) OPTICAL SCANNING DEVICE, IMAGE FORMING APPARATUS

(71) Applicant: KYOCERA Document Solutions Inc., Osaka (JP)

(72) Inventor: Hironobu Oi, Osaka (JP)

(21) Appl. No.: 15/007,565

(22) Filed: Jan. 27, 2016

(30) Foreign Application Priority Data
Jan. 29, 2015 (JP) 2015-015655

(51) Int. Cl. B41J 2/385

(52) U.S. Cl. CPC G03G 15/043; H04N 1/06; H04N 1/04

(57) ABSTRACT

An optical scanning device includes a light source, an optical element, a light deflector, a first storage portion, a second storage portion, and a correction processing portion. The first storage portion stores, in advance, first information that indicates relationship between positions on the image carrying member and light amounts of the laser beam irradiated on the image carrying member. The second storage portion stores, in advance, second information that indicates relationship between the control signal input to the light source and a light amount of the laser beam irradiated at a predetermined reference position of the image carrying member in the main scanning direction. The correction processing portion corrects the control signal for controlling the laser beam, based on the first information, the second information and information of irradiation positions on the image carrying member in the main scanning direction at which the laser beam is to be irradiated.

### INCORPORATION BY REFERENCE

This application is based upon and claims the benefit of priority from the corresponding Japanese Patent Application No. 2015-015655 filed on Jan. 29, 2015, the entire contents of which are incorporated herein by reference.

### BACKGROUND

The present disclosure relates to an optical scanning device and to an electrophotographic image forming apparatus including the optical scanning device.

In general, in an electrophotographic image forming apparatus, a laser beam emitted from a light source based on image data is deflected by a polygon mirror and scanned on the photoconductor drum, thereby an electrostatic latent image is formed on the photoconductor drum. In addition, in this type of image forming apparatus, the laser beam emitted from the light source is irradiated on the photoconductor drum after passing through various optical elements such as mirrors and lenses.

At this time, the light amount of the laser beam irradiated on the photoconductor drum may change depending on differences in optical characteristics of the optical elements disposed on the scanning path. For example, the reflectivity of a mirror may change if the incident angle or the incident position of the laser beam changes. In other words, the transmittance of a lens may change if the incident angle or the incident position of the laser beam changes. Due to such conditions, the light amount of the laser beam irradiated on the photoconductor drum may be smaller at ends of the photoconductor drum in the scanning direction than at the center. There is known a technology that detects the light amount of the laser beam irradiated on the photoconductor drum at a downstream of the optical elements, and corrects the light emission amount of the laser beam based on the detected light amount.

### SUMMARY

An optical scanning device according to an aspect of the present disclosure includes a light source, an optical element, a light deflector, a first storage portion, a second storage portion, and a correction processing portion. The light source emits a laser beam in response to an input control signal. The optical element is disposed between the light source and an image carrying member on which the laser beam is irradiated. The light deflector scans, in a main scanning direction, the laser beam emitted from the light source. The first storage portion stores first information in advance, the first information indicating relationship between positions on the image carrying member in the main scanning direction and light amounts of the laser beam irradiated on the image carrying member. The second storage portion stores second information in advance, the second information indicating relationship between the control signal input to the light source and a light amount of the laser beam irradiated at a predetermined reference position of the image carrying member in the main scanning direction. The correction processing portion corrects the control signal for controlling the laser beam, based on the first information, the second information and information of irradiation positions on the image carrying member in the main scanning direction at which the laser beam is to be irradiated.

An image forming apparatus according to another aspect of the present disclosure includes the optical scanning device and an image carrying member. On the image carrying member, the laser beam emitted from the optical scanning device is irradiated and an electrostatic latent image is formed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing the configuration of an image forming apparatus according to an embodiment of the present disclosure.

FIG. 2 is a schematic diagram showing a schematic configuration of an optical scanning device included in the image forming apparatus according to an embodiment of the present disclosure.

FIG. 3 is a block diagram showing a schematic configuration of a control portion included in the image forming apparatus according to an embodiment of the present disclosure.

FIG. 4 is a graph showing the relationship between positions on the photoconductor drum in the main scanning direction and the light amount of the laser beam irradiated on the photoconductor drum at the positions according to an embodiment of the present disclosure.

FIG. 5 is a diagram showing the relationship between a laser beam incident on an optical element of the optical scanning device included in the image forming apparatus according to an embodiment of the present disclosure, and the laser beam transmitting through the optical element.

FIG. 6A and FIG. 6B are graphs showing the relationship between the control signal input to a laser light source and the light amount of a laser beam irradiated at the center of the photoconductor drum in the main scanning direction according to an embodiment of the present disclosure.

FIG. 7 is a flowchart showing an example of a correction process executed by the control portion of the image forming apparatus according to an embodiment of the present disclosure.

### DETAILED DESCRIPTION

[Image forming apparatus 10]

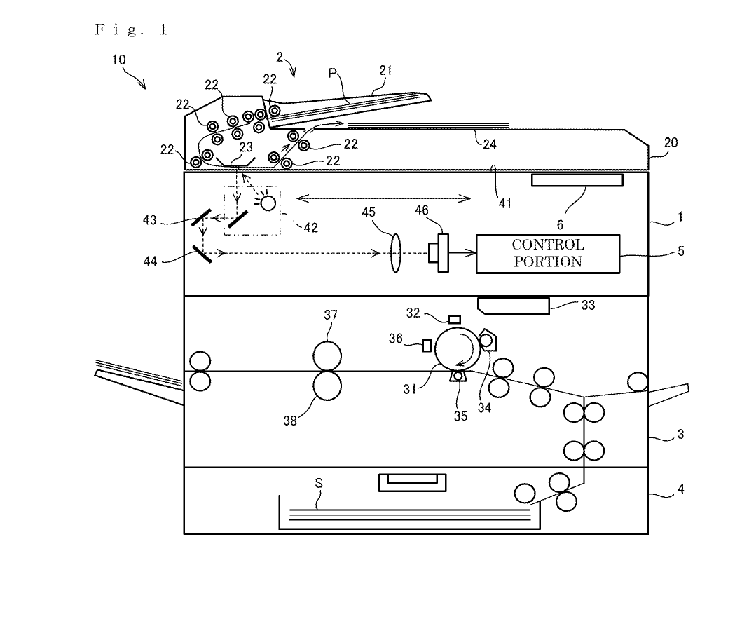

First, a schematic configuration of an image processing apparatus 10 according to an embodiment of the present disclosure is described with reference to FIG. 1.

The image processing apparatus 10 includes an image reading portion 1, an automatic document feeder (ADF) 2, an image forming portion 3, a sheet feed portion 4, a control portion 5, and an operation/display portion 6. The operation/display portion 6 is, for example, a touch panel for displaying various information in accordance with control instructions from the control portion 5, and inputting various information to the control portion 5 in response to user operations. It is noted that the present disclosure may be an image forming apparatus such as a printer, a facsimile apparatus, or a copier.

The image reading portion 1 includes a document sheet cover 20, a contact glass 41, a reading unit 42, mirrors 43 and 44, an optical lens 45, and a charge coupled device (CCD) 46. The ADF 2 is an automatic document feeder that includes a document sheet setting portion 21, a plurality of conveyance rollers 22, a document sheet pressing 23, and a sheet discharge portion 24.

The image forming portion 3 is an electrophotographic image forming portion that executes an image forming process based on image data read by the image reading portion 1, or image data input from an external information processing apparatus such as a personal computer.

The image forming portion 3 includes a photoconductor drum 31 as the image carrying member, a charging device 32, a laser scanning unit (LSU) 33, a developing device 34, a transfer roller 35, an electricity removing device 36, a fixing roller 37, and a pressure roller 38. The LSU 33 scans the surface of the photoconductor drum 31 with a laser beam L by irradiating the laser beam L from between the charging device 32 and the developing device 34 diagonally downward with respect to the surface of the photoconductor drum 31.

[Schematic configuration of LSU 33]

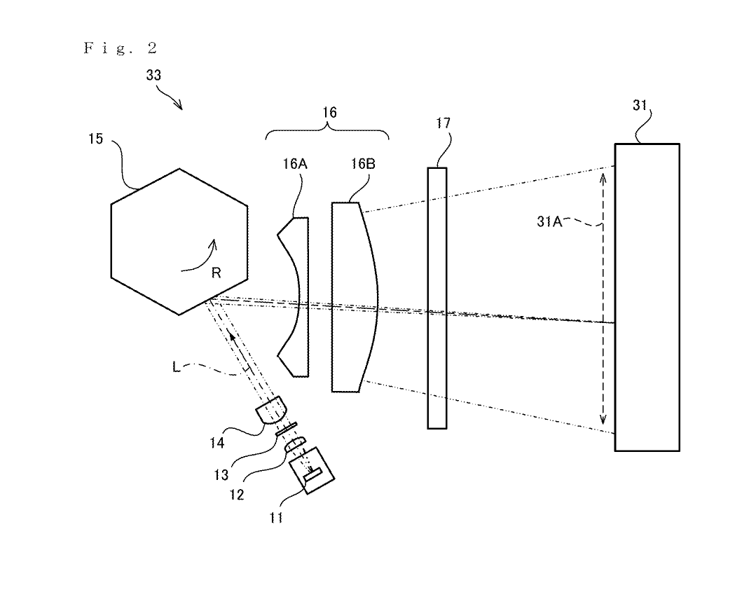

Next, a schematic configuration of the LSU 33 is described with reference to FIG. 2. As shown in FIG. 2, the LSU 33 includes a laser beam source 11, a coupling lens 12, an aperture 13, a cylindrical lens 14, a polygon mirror 15 (an example of the light deflector), an fθ lens 16, and a reflection mirror 17. It is noted that the coupling lens 12, the aperture 13, the cylindrical lens 14, the fθ lens 16, and the reflection mirror 17 are an example of the optical element.

The laser beam source 11 emits a laser beam in response to a control signal input thereto. The amount (light emission amount) of the laser light emitted from the laser beam source 11 in response to a driving current input thereto tends to be varied depending on the difference in the manufacturing process or installation position of the laser beam source 11, but the laser beam source 11 has a property of being difficult to change over time. It is noted that in the following description, it is supposed that the laser beam source 11 is a single light emitting point type that emits a laser beam L from a single light emitting point. However, the laser beam source 11 may be a multi light emitting point type that emits a plurality of laser beams L from a plurality of light emitting points arranged in alignment in a predetermined direction. In addition, the control signal indicates a value of the driving current that drives the laser beam source 11, or a value of image data that can be an index of the driving current. The control signal is described in detail below.

The coupling lens 12 is a collemator lens configured to approximately collemate the laser beams L emitted from the laser beam source 11. The aperture 13 shapes the laser beams L by shielding the peripheral flux region of the laser beams L collemated by the coupling lens 12. The cylindrical lens 14 converges the laser beams L shaped by the aperture 13 in a sub scanning direction, thereby forming a line-like image that is elongated in a main scanning direction 31A on a reflection surface of the polygon mirror 15.

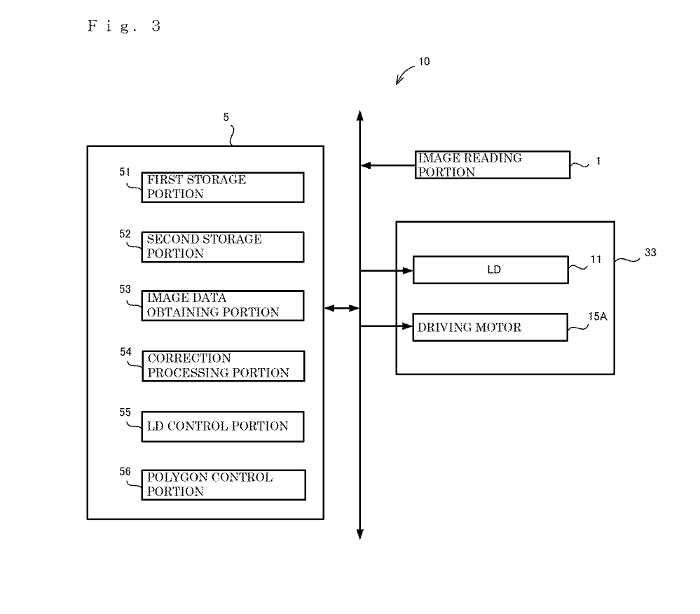

The polygon mirror 15 is rotationally driven by a driving motor 15A (see FIG. 3) in an arrow R direction (see FIG. 2), thereby reflecting (deflecting) the laser beam L emitted from the laser beam source 11 in a predetermined direction such that the reflected laser beam L scans the photoconductor drum 31 in the main scanning direction 31A. The polygon mirror 15 is a rotary polygon mirror having six reflection surfaces that reflect the laser beams L emitted from the laser beam source 11. The driving motor 15A is disposed below the polygon mirror 15 in the vertical direction. The polygon mirror 15 is connected to the output shaft of the driving motor 15A. With this configuration, when the driving motor 15A is rotationally driven by the control portion 5, the polygon mirror 15 is rotated around the output shaft. It is noted that although the polygon mirror 15 shown in FIG. 2 has a regular hexagonal shape, the polygon mirror 15 may have another regular polygonal shape.

The fθ lens 16 converts an equiangular velocity motion of the laser beam L applied by the polygon mirror 15, to an equal velocity motion such that an image is formed on the surface of the photoconductor drum 31. In the LSU 33, the fθ lens 16 is a set lens including a plurality of aspherical lenses (including at least a lens 16A and a lens 16B) (see FIG. 2). It is noted that the fθ lens 16 may be a single lens.

The reflection mirror 17 is formed in the shape of a long plate that extends along the main scanning direction 31A in which the laser beam L is scanned by the polygon mirror 15. The reflection mirror 17 reflects the laser beam L that has been converted to the equal velocity motion by the fθ lens 16, and guides the laser beam L to the photoconductor drum 31.

Meanwhile, the light amount of the laser beam L irradiated on the photoconductor drum 31 is smaller at ends thereof in the main scanning direction 31A than at the center thereof. The reduction in the light amount occurs due to the difference in the optical characteristics of the optical elements disposed on the scanning path. For example, with regard to the polygon mirror 15 and the reflection mirror 17, the reflectivity changes if the incident angle or the incident position of the laser beam L changes. In addition, with regard to the coupling lens 12 and the fθ lens 16, the transmittance of the lens changes if the incident angle or the incident position of the laser beam L changes. As a result, the light emission amount of the laser beam L at the laser beam source 11 needs to be corrected in correspondence with the irradiation position of the laser beam L on the photoconductor drum 31 in the main scanning direction 31A. It is noted that there is known an image forming apparatus that controls the light emission amount of the laser beam L by using a sensor for detecting the light amounts at different irradiation positions on the photoconductor drum 31, and a sensor for detecting the light emission amount at the laser beam source 11. However, this technology has a problem that it requires a lot of parts to correct the variation in the light amounts of the laser beam L at various irradiation positions on the photoconductor drum 31 in the main scanning direction 31A, thus hindering the cost reduction. On the other hand, in the image forming apparatus 10, the control portion 5 performs a light amount equalization process described below so that the light amounts of the laser beam L at the irradiation positions on the photoconductor drum 31 in the main scanning direction 31A each become the same as the light amount of the laser beam L at the center of the photoconductor drum 31 in the main scanning direction 31A, and thereby the light amounts of the laser beams L irradiated on the photoconductor drum 31 become approximately equal over the entire image height in the main scanning direction 31A.

The control portion 5 is a microcomputer including a CPU, a ROM, a RAM, and a DRIVER, and controls the operation of the image forming apparatus 10. The ROM stores a control program for executing an image forming process. The CPU is a processor that controls the elements connected to the control portion 5 by executing the control program stored in the ROM. The RAM is used as a working area (primary storage area) for the various processes executed by the CPU. The DRIVER is a circuit for driving the driving motor 15A and the like in accordance with control instructions from the CPU. It is noted that the control portion 5 may be composed of electronic circuits such as integrated circuits (ASIC, DSP).

As shown in FIG. 3, the ROM includes storage areas such as a first storage portion 51 and a second storage portion 52 for respectively storing first information and second information that are used in the light amount equalization process. Furthermore, the ROM stores a table of electric current values of the driving current in correspondence with input data values.

The first information is a table or the like that indicates the light amounts of the laser beam L at irradiation positions on the photoconductor drum 31 in the main scanning direction 31A, on the basis of the light amount at a predetermined reference position in the main scanning direction 31A. Specifically, the first information is information that is obtained in advance by simulation, or information that is determined in advance based on the measurement results of the light amounts. For example, in the similation, the first information is obtained based on the disposition and characteristics of the optical elements and the polygon mirror 15 installed in the image forming apparatus 10. In addition, when the light amounts are measured, the first information is determined in advance based on the detection results of an optical amount detecting portion such as a light reception sensor that is temporarily disposed between the optical elements and the photoconductor drum 31.

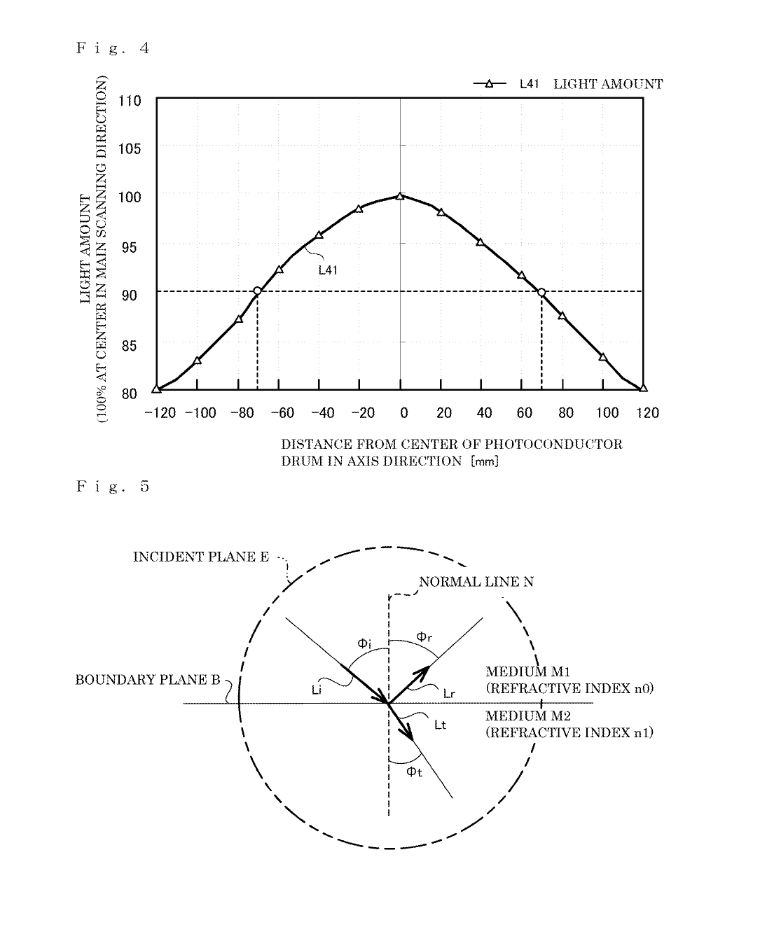

FIG. 4 shows an example of the first information. The horizontal axis of FIG. 4 represents positions on the photoconductor drum 31 in the main scanning direction 31A, as respective distances from the center of the photoconductor drum 31 in the main scanning direction 31A, with the center being set as 0. The vertical axis of FIG. 4 represents, by percentage, the light amounts of the laser beam L irradiated on the photoconductor drum 31, with the light amount at the center being set as a reference value, 100%. It is noted that the vertical axis of FIG. 4 represents the light amounts on the condition that the laser beam source 11 emits each laser beam L with a constant amount.

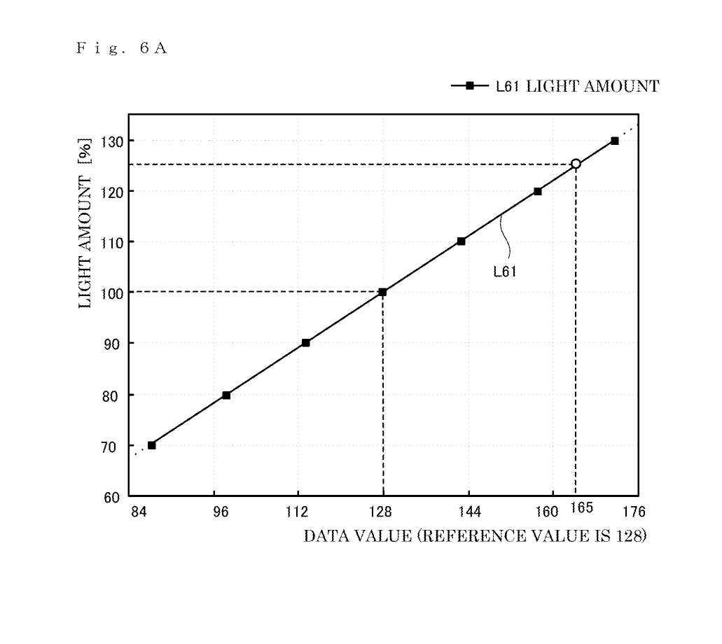

The laser beam L emitted from the laser beam source 11 transmits through an air layer and is incident on and transmits through a boundary plane between media having different transmittances, such as the air layer and the optical element disposed on the scanning path, and is then irradiated on the surface of the photoconductor drum 31. Since the laser beam L is scanned in the main scanning direction 31A, the incident angle and the incident position of the laser beam L on the optical element disposed on the scanning path, are varied. As shown in FIG. 5, in general, when an incident plane E is a plane being perpendicular to a boundary plane B and including an incident laser beam Li and a reflection laser beam Lr, the transmittance of a light component (p-polarized light component) in which the orientation of the oscillation of the electric field is parallel to the incident plane E is different from the transmittance of a light component (s-polarized light component) in which the orientation of the oscillation of the electric field is vertical to the incident plane E. As a result, in the laser beam L, in response to the variation of the incident angle to the optical element, the separation in transmittance between the p-polarized light component and the s-polarized light component increases, and the light amount on the surface of the photoconductor drum 31 is varied.

The laser beam source 11 is installed in the LSU 33 with an installation angle at which the light amount of the laser beam L irradiated at the reference position in the main scanning direction 31A becomes the largest. The optical path length of the laser beam L becomes the shortest when the irradiation position is at the center, becomes longer as the irradiation position moves from the center toward either end, and becomes the longest when the irradiation position is at either end. The center is equally distanced from both ends. For this reason, the center may be set as the reference position. In addition, an incident angle on the optical element of the laser beam L that is irradiated at the center may be set as a reference incident angle. This makes it possible to associate the distance from the center with the incident angle of the laser beam L that is incident on the optical element. As a result, in the laser beam L scanned by the polygon mirror 15, when the incident angle is deviated from the reference incident angle, the separation in transmittance between the p-polarized light component and the s-polarized light component increases. As the separation in transmittance increases, the light amount of the laser beam L transmitting through the optical elements attenuates, and the light amount at the irradiation position is decreased. Here, when the light amounts of the laser beam L irradiated at the irradiation positions on the photoconductor drum 31 in the main scanning direction 31A are indicated by percentage, wherein the light amount at the center is set as the reference value, a graph projecting upward is obtained as indicated by a solid line L41 in FIG. 4.

The first information shown in FIG. 4 may be obtained by a simulation based on the equations (1) and (2) provided below. The following describes the transmittance in the case where the laser beam L is obliquely incident on the boundary plane B. Here, as shown in FIG. 5, “Li” denotes an incident laser beam that is a laser beam L incident on the boundary plane B between media M1 and M2 after transmitting through the medium M1; “Φi” denotes an incident angle that is an angle between the incident laser beam Li and a normal line N that is perpendicular to the boundary plane B; “Lr” denotes a reflection laser beam that is a laser beam L reflected on the boundary plane B; “Φr” denotes a reflection angle that is an angle between the reflection laser beam Lr and the normal line N; “Lt” denotes a transmission laser beam that is a laser beam L that has transmitted through the boundary plane B to the medium M2 side; and “Φt” denotes a refraction angle that is an angle between the transmission laser beam Lt and the normal line N. In addition, it is supposed that the media M1 and M2 have different refractive indices, the refractive index of the medium M1 is n0 (n0=1, for convenience's sake), and the refractive index of the medium M2 is n1. In the present embodiment, it is presumed that light absorption does not occur inside the optical element such as the fθ lens 16, and a relationship “transmittance=1−refractive index” is satisfied. It is noted that, to reduce the amount of calculation of the simulation, the refractive index of the medium through which the incident laser beam Li transmits before being incident on the boundary plane B can be set to 1, and the refractive index of the air layer can be set to 1. This is because an error caused by the setting in the simulation is small enough to disregard its influence.

Under the above-described conditions, a transmittance Tp of the p-polarized light component is represented by the following equation (1), and a transmittance Ts of the s-polarized light component is represented by the following equation (2).

$$\begin{matrix}[ Math . 1 ] & \\ {T}_{p} = \frac{4 {n}_{1} cos {φ}_{i} cos {φ}_{t}}{{( cos {φ}_{t} + {n}_{1} cos {φ}_{i} )}^{2}} & ( 1 ) \\ [ Math . 2 ] & \\ {T}_{s} = \frac{4 {n}_{1} cos {φ}_{i} cos {φ}_{t}}{{( cos {φ}_{i} + {n}_{1} cos {φ}_{t} )}^{2}} & ( 2 )\end{matrix}$$

With regard to the laser beam L that is emitted from the laser beam source 11 while maintaining a predetermined light emission amount, the equation (1) and the equation (2) are applied to the polygon mirror 15, the fθ lens 16 and the reflection mirror 17 that are included in the LSU 33. These portions constitute the optical elements that are disposed on the scanning path of the laser beam L that has been deflected by the polygon mirror 15. In this way, the equation (1) and the equation (2) may be applied at least to the optical element that is composed of the portions that are disposed on the scanning path of the laser beam L that has been deflected by the polygon mirror 15, and may not be applied to all optical elements. This is because the light amounts at the irradiation positions on the photoconductor drum 31 can be calculated if the ratio in light amount between the center and each of the irradiation positions on the photoconductor drum 31 can be obtained, and there is no need to obtain accurate values of the light amount of the laser beam L transmitting through the optical elements (in the present embodiment, the coupling lens 12, the aperture 13 and the cylindrical lens 14) that are disposed on the scanning path of the laser beam L before being deflected by the polygon mirror 15.

As described above, values of the transmittance Tp and the transmittance Ts are obtained by applying the equation (1) and the equation (2) to the optical elements, and, based on the obtained values of the transmittance Tp and the transmittance Ts, the light amounts at the irradiation positions on the photoconductor drum 31 in the main scanning direction 31A can be obtained, and the first information is obtained by the simulation. It is noted that the scanning path of the laser beam L is included in a plane that is perpendicular to the incident plane E (the plane is extending in a direction perpendicular to the plane of FIG. 5).

Here, the first information is determined in advance by the arrangement position and the arrangement angle of the polygon mirror 15, the fθ lens 16, and the reflection mirror 17 that are positioned on the scanning path of the laser beam L. That is, in a plurality of image forming apparatuses 10 of the same type, the first information can be used in common. As a result, the first information is stored in the ROM in advance as information that is common to the image forming apparatuses 10 of the same type.

The second information is a table or the like that includes: values of the control signal that is input to the laser beam source 11; and values of the light amount of the laser beam L at a predetermined position on the photoconductor drum 31 in the main scanning direction 31A. For example, the second information indicates, by percentage, the light amounts of the laser beam L at the center of the photoconductor drum 31 in the main scanning direction 31A, wherein a light amount that corresponds to a predetermined reference value of the control signal is set as 100%. The second information is information that is measured in advance for each laser beam source 11 installed in the image forming apparatus 10. Here, the control signal is a data value that can be an index of the driving current that is input to the laser beam source 11. Alternatively, the control signal is a current value of the driving current that is input to the laser beam source 11.

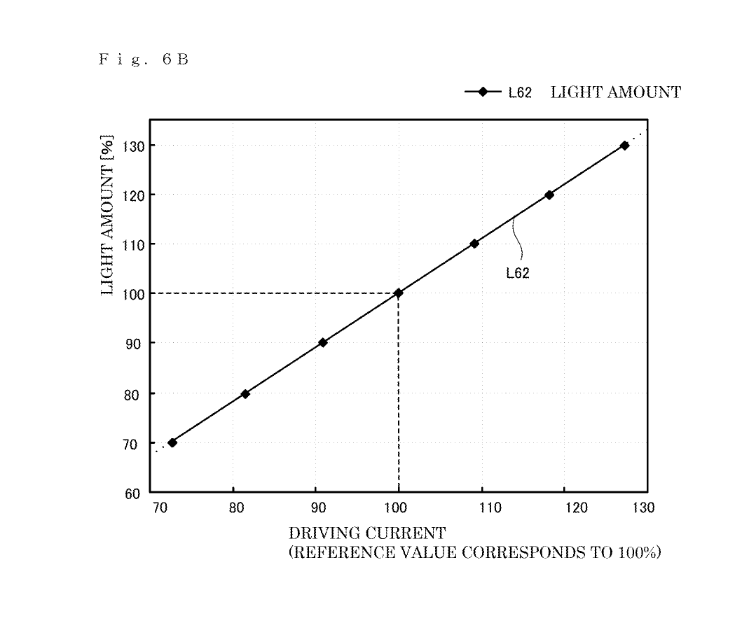

FIG. 6A and FIG. 6B are examples of the second information. FIG. 6A is a graph showing the relationship between the data value that controls the light emission amount of the laser beam L, and the light amount of the laser beam L at the center of the photoconductor drum 31 in the main scanning direction 31A. FIG. 6B is a graph showing the relationship between the current value of the driving current that is input to the laser beam source 11, and the light amount of the laser beam L at the center of the photoconductor drum 31 in the main scanning direction 31A. The horizontal axis of FIG. 6A represents the data value that controls the light emission amount of the laser beam source 11. In the horizontal axis, the data value that can be an index of the current value of the driving current is set as the reference value “128” when the light amount of the laser beam L at the center of the photoconductor drum 31 in the main scanning direction 31A is a reference light amount “100%”. The vertical axis of FIG. 6A represents the light amounts of the laser beam L, wherein the reference light amount is set as “100%”. The horizontal axis of FIG. 6B represents the current amount of the driving current that controls the light emission amount of the laser beam source 11. In the horizontal axis, the current value of the driving current is set as the reference value “100%” when the light amount of the laser beam L at the center of the photoconductor drum 31 in the main scanning direction 31A is the reference light amount “100%”. The vertical axis of FIG. 6B represents the light amount of the laser beam L at the center of the photoconductor drum 31 in the main scanning direction 31A, wherein the reference light amount is set as “100%”.

The light emission amount of the laser beam L is varied in response to a variation of the signal which indicates the data value that can be an index of the current value of the driving current for driving the laser beam source 11. The light emission amount of the laser beam L is proportional to the data value. However, due to the individual variation of the laser beam source 11, the amount of the variation of the light emission amount of the laser beam L that corresponds to the amount of variation of the data value, differs for each individual laser beam source 11. That is, the constant of proportionality between the data value and the light emission amount of the laser beam L differs for each individual laser beam source 11.

In addition, the light emission amount of the laser beam L is varied in response to a variation of the current amount of the driving current input to the laser beam source 11. As a result, as is the case with the data value, the second information may be such information that indicates the relationship between the current value of the driving current input to the laser beam source 11 and the light amount of the laser beam L at the center of the photoconductor drum 31 in the main scanning direction 31A. The amount of variation of the light emission amount of the laser beam L that corresponds to the amount of variation of the current value of the driving current depends on the individual variation of the installed laser beam source 11. In other words, since the light emission amount of the laser beam L differs for each individual laser beam source 11, the light amount of laser beam L at the center of the photoconductor drum 31 in the main scanning direction 31A differs for each individual laser beam source 11. As a result, the second information is measured in advance for each installed individual laser beam source 11.

Next, the relationship between the first information and the second information is explained. The reference light amount (the light amount represented as “100%” in FIG. 4) of the first information and the reference light amount (the light amount represented as “100%” in FIG. 6A or FIG. 6B) of the second information are set as the same light amount. It is noted that the reference light amount is, for example, a light amount with which an electrostatic latent image of a desired potential is formed on the photoconductor drum 31. When the data value “128” is input to the driving driver of the laser beam source 11, the light amount of the laser beam L at the center of the photoconductor drum 31 in the main scanning direction 31A becomes “100%” that is the reference light amount, and the light amount of the laser beam L at either end (represented as “−120 mm” and “120 mm” in FIG. 4) of the photoconductor drum 31 in the main scanning direction 31A becomes “80%”.

By setting the reference light amounts of the first information and the second information as the same light amount, one line of correction data in the main scanning direction 31A can be obtained. The one line of correction data is information that causes the control signal input to the laser beam source 11 to change in correspondence with the light amount of the laser beam L at each irradiation position in the main scanning direction 31A. The one line of correction data is set individually for each image forming apparatus 10 based on the laser beam source 11 installed therein, and is created by the control portion 5 during the light amount equalization process. Meanwhile, there is known a method for obtaining one line of correction data individually for each image forming apparatus manufactured, and correcting the variation of the light amount of the laser beam L irradiated on the photoconductor drum 31 in the main scanning direction 31A. However, the method has a problem that a processing step needs to be provided for each manufactured image forming apparatus to obtain the one line of correction data, which increases the manufacturing time. On the other hand, the image forming apparatus 10 uses, as the first information, information that is common to a plurality of image forming apparatuses 10 of the same type, and thus only a processing step for measuring the second information is required. As a result, in the manufacturing process, the time for manufacturing the image forming apparatus 10 can be reduced. In this way, in the image forming apparatus 10, it is not necessary to measure, for each installed laser beam source 11, the one line of correction data that causes the control signal input to the laser beam source 11 to change in correspondence with the light amount of the laser beam L at each of the irradiation positions in the main scanning direction 31A.

The control portion 5 functions as an image data obtaining portion 53, a correction processing portion 54, an LD control portion 55, and a polygon control portion 56 by executing the control program by using the CPU.

The image data obtaining portion 53 obtains image data that is read from a document sheet by the image reading portion 1, or image data input from another information processing apparatus, and stores the obtained image data.

The LD control portion 55 controls the emission of the laser beam L by the laser beam source 11. The polygon control portion 56 rotates the polygon mirror 15 by controlling the rotational driving of the driving motor 15A.

The correction processing portion 54 corrects the control signal for controlling the laser beam L based on the first information, the second information, and information of the irradiation positions of the laser beam L on the photoconductor drum 31 in the main scanning direction 31A. It is noted that the information of the irradiation positions is calculated from the rotation speed of the polygon mirror 15 and an elapsed time since a laser beam was incident on a light reception sensor (BD sensor: not shown) that is disposed at a predetermined position outside an effective image formation area in the main scanning direction 31A. The correction processing portion 54 makes a correction such that the light amount of a laser beam L that is emitted from the laser beam source 11 based on the control signal and irradiated on the photoconductor drum 31 is constant regardless of the irradiation position on the photoconductor drum 31 in the main scanning direction 31A. In other words, the correction processing portion 54 corrects the control signal so that the light amount of the laser beam L that is irradiated at an irradiation position different from the center of the photoconductor drum 31 in the main scanning direction 31A, is close to the light amount of the laser beam L irradiated at the center of the photoconductor drum 31 in the main scanning direction 31A.

Here, a description is given of an example of the correction process which is executed by the correction processing portion 54 based on the first information and the second information. Here, for the sake of explanation, it is supposed in this example that a value “128” is input as a data value that corresponds to the main scanning direction 31A of the photoconductor drum 31.

For example, in FIG. 4, the light amounts at first positions (represented by white circles) are each 90%, the first positions being respectively plus 70 mm and minus 70 mm from the center. As a result, in order to change the light amounts at the first positions to “100%”, the correction processing portion 54 calculates the value “X1” from the equation “100:90=X1:100”. The value “X1” is approximately 111%. That is, by inputting a control signal with a value that causes the light amount of the laser beam L to be 111% at the center of the photoconductor drum 31 in the main scanning direction 31A, it is possible to set the light amounts of the laser beam L at the first positions to 100%. Accordingly, the correction processing portion 54 refers to the table shown in FIG. 6A, and extracts a data value “144” that sets the light emission amount at the laser beam source 11 to 111%, and changes the data value from “128” to “144”.

Similarly, in FIG. 4, the light amounts at second positions are each 80%, the second positions being respectively plus 120 mm and minus 120 mm from the center. As a result, in order to change the light amounts at the second positions to “100%”, the correction processing portion 54 calculates the value “X2” from the equation “100:80=X2:100”. The value “X2” is approximately 125%. Accordingly, the correction processing portion 54 refers to the table shown in FIG. 6A, and extracts a data value “165” that sets the light emission amount at the laser beam source 11 to 125%, and changes the data value from “128” to “165”.

In this way, the correction processing portion 54 corrects the light amount at each of all irradiation positions in the main scanning direction 31A to be the same as the light amount at the center.

[Light Amount Equalization Process]

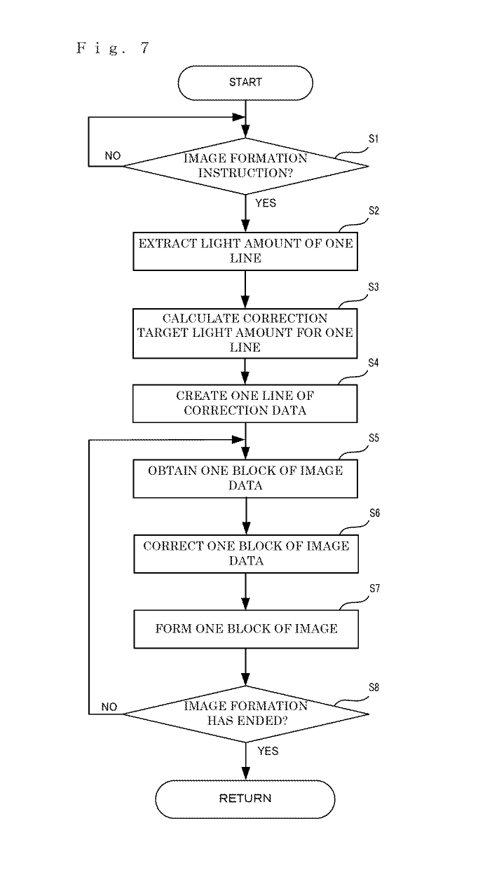

The following explains the procedure of the light amount equalization process executed by the control portion 5, with reference to FIG. 7. In the flowchart of FIG. 7, steps S1, S2, . . . represent processing procedure (step) numbers. It is noted that the control portion 5 executes the light amount equalization process when the image forming apparatus 10 executes the image forming process. Here, the light amount equalization process is executed by the correction processing portion 54.

<Step S1>

In step S1, the control portion 5 determines whether or not an image formation instruction for the image forming apparatus 10 has been input. Specifically, the control portion 5 determines that the image formation instruction has been input when the user has input the image formation instruction to the operation/display portion 6, or when the image formation instruction has been received from another information processing apparatus. Upon determining that the image formation instruction has been input (Yes side at S1), the control portion 5 moves the process to step S2. It is noted that the control portion 5 causes the process to wait at step S1 (No side at S1) until it determines that the image formation instruction has been input.

<Step S2>

In step S2, the control portion 5 extracts light amounts at positions in the main scanning direction 31A from the first information. Here, image data that is obtained when the LSU 33 scans once in the main scanning direction 31A is referred to as one line of image data. The one line of image data includes a plurality of pieces of pixel image data that respectively correspond to a plurality of pixels aligned along the main scanning direction 31A. The control portion 5 extracts, from the first information, the light amount for each of the plurality of pieces of pixel image data to correct the one line of image data. In the example shown in FIG. 4, the light amount of the pixel image data is 100% when the laser beam is irradiated at the center, 90% when the laser beam is irradiated at the first positions, and 80% when the laser beam is irradiated at the second positions.

<Step S3>

In step S3, the control portion 5 calculates the light amount (hereinafter referred to as “correction target light amount”) of the laser beam L at the center of the photoconductor drum 31 in the main scanning direction 31A that is used to change the light emission amount at the laser beam source 11 so that the light amounts at the irradiation positions in the main scanning direction 31A become the same as the light amount at the center. In the example shown in FIG. 4, the correction target light amounts are 100% at the center, 111% at the first positions, and 125% at the second positions.

<Step S4>

In step S4, the control portion 5 extracts, from the second information, the data value or driving current of the control signal for each irradiation position in the main scanning direction 31A, and creates one line of correction data for correcting the data value of the image data. The control portion 5 extracts, from the second information, the data value of the control signal corresponding to the pixel image data at each irradiation position in the main scanning direction 31A, and assigns the extracted data value. In the example shown in FIG. 6A, the control portion 5 assigns the data value “128” of the control signal that corresponds to 100%, to the pixel image data at the center. Similarly, the control portion 5 assigns the data value “144” of the control signal that corresponds to 111%, to the pixel image data at the first positions, and assigns the data value “165” of the control signal that corresponds to 125%, to the pixel image data at the second positions.

The one line of correction data is determined such that the light amount at each of all irradiation positions in the main scanning direction 31A becomes the same as the light amount at the center. The control portion 5 is configured to restrict the variation of the light amount of the laser beam L in the main scanning direction 31A, with a simple configuration using one line of correction data.

<Step S5>

In step S5, the control portion 5 obtains one block of image data to be processed collectively, from among the image data forming the image. Here, the one block of image data is a block of a plurality of continuous lines of image data. For example, the control portion 5 obtains 20 to 30 continuous lines of image data from the image data.

<Step S6>

In step S6, the control portion 5 corrects, one line by one line, the one block of image data obtained in step S5, by using the one line of correction data extracted in step S2. With this operation, the laser beams L to be irradiated on the photoconductor drum 31 are corrected such that the light amount of each pixel image data becomes the same regardless of the position in the main scanning direction 31A.

<Step S7>

In step S7, the control portion 5 drives the laser beam source 11 such that the laser beam L is irradiated on the photoconductor drum 31 based on the one block of image data. With this operation, an electrostatic latent image is formed on the photoconductor drum 31 based on the one block of image data.

<Step S8>

In step S8, the control portion 5 determines whether or not the image formation process has ended. Upon determining that the image formation process has not ended (No side at S8), the control portion 5 moves the process to step S5. With this operation, during the image formation process, the control portion 5 corrects the one block of image data collectively and forms an electrostatic latent image in which the light amount of each pixel image data is the same regardless of the position in the main scanning direction 31A. On the other hand, upon determining that the image formation process has ended (Yes side at S8), the control portion 5 returns the process to step 51, and waits for the next image formation instruction.

As described above, according to the image forming apparatus 10, the light emission amount at the laser beam source 11 is controlled based on the first information and the second information, wherein the first information is common to the image forming apparatuses 10 of a same type, and the second information is prepared individually for each laser beam source 11 installed. With this configuration, in the image forming apparatus 10, the variation of the light amount of the laser beam L irradiated on the photoconductor drum 31 in the main scanning direction 31A can be restricted with a simple configuration.

### OTHER EMBODIMENTS

In the above-described embodiment, the control signal input to the laser beam source 11 is a data value that can be an index of the driving current. However, the present disclosure is not limited to this. The control signal may be in another form as far as it varies the light emission amount of the laser beam L emitted from the laser beam source 11. The control signal may be a current value of the driving current that is input to the laser beam source 11. This is effective in the case where the pixel image data has a small number of gradations and the adjustment width of the current value of the driving current is minuter than the number of gradations.

In the above-described embodiment, the one line of correction data is created in response to an input of an image formation instruction. However, the present disclosure is not limited to this. One line of correction data may be created and stored in the storage portion at the initial activation, and the one line of correction data may be read and used during an image formation. This reduces the processing time of the image formation process.

In the above-described embodiment, the reference position in the first information is set to the center in the main scanning direction 31A. However, the present disclosure is not limited to the configuration. For example, the start position from which the scanning by the laser beam L is started may be set as the reference position.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An optical scanning device comprising:
a light source configured to emit a laser beam in response to an input control signal;
an optical element disposed between the light source and an image carrying member on which the laser beam is irradiated;
a light deflector configured to scan, in a main scanning direction, the laser beam emitted from the light source;
a first storage portion configured to store first information in advance, the first information indicating relationship between positions on the image carrying member in the main scanning direction and light amounts of the laser beam irradiated on the image carrying member;
a second storage portion configured to store second information in advance, the second information indicating relationship between the control signal input to the light source and a light amount of the laser beam irradiated at a predetermined reference position of the image carrying member in the main scanning direction; and
a correction processing portion configured to correct the control signal for controlling the laser beam, based on the first information, the second information and information of irradiation positions on the image carrying member in the main scanning direction at which the laser beam is to be irradiated.

2. The optical scanning device according to claim 1, wherein
a center of the image carrying member in the main scanning direction is set as the reference position, and the correction processing portion corrects the control signal so that a light amount of the laser beam that is irradiated at an irradiation position different from the reference position is close to the light amount of the laser beam irradiated at the reference position.

3. The optical scanning device according to claim 1, wherein
the first information is obtained in advance based on characteristics of the optical element and the light deflector.

4. The optical scanning device according to claim 3, wherein
the laser beam emitted from the light source transmits through an air layer and is incident on and transmits through a boundary plane between media having different transmittances, the media being the air layer and the optical element disposed on a scanning path of a scanning by the laser beam, and
the first information is determined based on values of a transmittance Tp of a p-polarized light component and a transmittance Ts of an s-polarized light component calculated by using an equation (1) and an equation (2) with regard to the laser beam that is emitted from the light source while maintaining a predetermined light emission amount and is deflected by the light deflector, the p-polarized light component and the s-polarized light component being components of the optical element that is disposed on the scanning path of the laser beam that has been deflected by the light deflector,
$$\begin{matrix}[ Math . 3 ] & \\ {T}_{p} = \frac{4 {n}_{1} cos {φ}_{i} cos {φ}_{t}}{{( cos {φ}_{t} + {n}_{1} cos {φ}_{i} )}^{2}} , & ( 1 ) \\ [ Math . 4 ] & \\ {T}_{s} = \frac{4 {n}_{1} cos {φ}_{i} cos {φ}_{t}}{{( cos {φ}_{i} + {n}_{1} cos {φ}_{t} )}^{2}} , & ( 2 )\end{matrix}$$
wherein
“Φi” denotes an incident angle that is an angle between the laser beam that is incident on the boundary plane and a normal line that is perpendicular to the boundary plane, “Φt” denotes a refraction angle that is an angle between the normal line and the laser beam that has transmitted through the boundary plane, a refractive index of the air layer and a medium through which the laser beam transmits before being incident on the boundary plane is set to 1, a refractive index of a medium through which the laser beam transmits through after transmitting through the boundary plane is set to n1, and the irradiation positions respectively correspond to incident angles Φi.

5. The optical scanning device according to claim 1, wherein
the first information is determined in advance based on detection results of an optical amount detecting portion that is temporarily disposed between the optical element and the image carrying member.

6. The optical scanning device according to claim 1, wherein
the second information is information that is measured in advance with regard to the light source installed.

7. The optical scanning device according to claim 1, wherein
the control signal indicates a current value input to the light source, or a value that can be an index of the current value.

8. An image forming apparatus comprising:
the optical scanning device according to claim 1; and
the image carrying member on which the laser beam emitted from the optical scanning device is irradiated and an electrostatic latent image is formed.
